(19) United States
(12) Patent Application Publication
(10) Pub. No.: US 2025/0224657 A1
(43) Pub. Date: Jul. 10, 2025

(54) PROJECTION APPARATUS, ACTIVE STATE REGULATION APPARATUS, POLARIZATION CONTROL APPARATUS, AND CIRCADIAN RHYTHM CONTROL APPARATUS

(71) Applicant: SEIKO EPSON CORPORATION, Tokyo (JP)

(72) Inventors: Minoru MORIWAKI, Matsumoto-shi (JP); Shuhei YAMADA, Chino-shi (JP); Yutaka TSUCHIYA, Hara-mura (JP); Naoki TOMIKAWA, Fujimi-machi (JP)

(73) Assignee: SEIKO EPSON CORPORATION, Tokyo (JP)

(21) Appl. No.: 19/013,243

(22) Filed: Jan. 8, 2025

(30) Foreign Application Priority Data
Jan. 9, 2024 (JP) 2024-001129

(51) Int. Cl. G03B 21/00; G03B 21/20

(52) U.S. Cl. CPC G03B 21/006; G03B 21/2073

(57) ABSTRACT

A projection apparatus includes light modulator to modulate incident light based on image signal; a projection lens configured to project light output from light modulator; and polarization control apparatus at light exiting side of light modulator in optical path of light output from light modulator and to be projected by projection lens, and configured to control polarization state of light modulated by light modulator, polarization control apparatus including first substrate, second substrate disposed to face first substrate, first organic film layered on first substrate and having no orientation regulating force that regulates orientations of liquid crystal molecules, second organic film layered on second substrate and having no orientation regulating force that regulates orientations of liquid crystal molecules, and liquid crystal layer between first and second organic film, liquid crystal layer containing multiple liquid crystal molecules arranged with major axes thereof oriented disorderly with respect to first and second organic films.

The present application is based on, and claims priority from JP Application Serial Number 2024-001129, filed Jan. 9, 2024, the disclosure of which is hereby incorporated by reference herein in its entirety.

### BACKGROUND

### 1. Technical Field

The present disclosure relates to a projection apparatus, an active state regulation apparatus, a polarization control apparatus, and a circadian rhythm control apparatus.

### 2. Related Art

There is a known projecting apparatus including a light combining section that combines red light, green light, and blue light with one another and outputs the combined light, a polarization converting section, and a projection lens (see JP-A-2013-113984, for example).

In the projecting apparatus described in JP-A-2013-113984, the polarization converting section converts the polarization state of the color light output from the light combining section into an omnidirectional non-polarized state. Specifically, the polarization converting section is any one of a wavelength-selective half-wave plate that shifts the phase by n for a predetermined wavelength, a uniaxial organic material that is an organic material having one optic axis (optical axis), and a uniaxial crystal that is a crystal having one optic axis. The polarization converting section is disposed between the light combining section and the projection lens to convert the three types of polarized color r light having the respective wavelengths out of the combined light output from the light combining section into three types of polarized light different from one another on the wavelength basis to achieve an omnidirectionally bias-free, uniform non-polarized state.

The projection lens projects the non-polarized light produced by the polarization converting section. The projection light projected from the projection apparatus toward a screen therefore has an omnidirectionally uniform non-polarized state.

A viewer wears active-shutter-type 3D glasses. The active-shutter-type 3D glasses cause a left eye image to enter the left eye of the viewer and a right eye image to enter the right eye of the viewer by alternately blocking the left eye image and the right eye image alternately displayed by the projection apparatus in synchronization with the operation of switching the images from one to the other. The 3D glasses thus generate parallax to enable stereoscopic viewing.

Such a projection apparatus can eliminate color unevenness in the 3D image in a state in which the 3D glasses are not tilted, and eliminate color unevenness and luminance loss in the 3D image in a state in which the 3D glasses are tilted, so that the image quality of the 3D image can be improved.

JP-A-2013-113984 is an example of the related art.

In the projection apparatus described in JP-A-2013-113984, however, a polarization converting section configured, for example, with the retardation film described above converts the incident light into non-polarized light by converting polarized light into polarized light containing multiple types of color polarized light having polarization states different from one another on a wavelength basis to lower the degree of polarization, that is, into non-polarized light, resulting in a problem of an insufficient degree of no polarization.

It has therefore been desired to provide a configuration capable of outputting light having a more random polarization state.

### SUMMARY

A projection apparatus according to a first aspect of the present disclosure includes: a light modulator configured to modulate incident light based on an image signal; a projection lens configured to project light output from the light modulator; and a polarization control apparatus disposed at a light exiting side of the light modulator in an optical path of the light output from the light modulator and to be projected by the projection lens, and configured to control a polarization state of the light modulated by the light modulator, the polarization control apparatus including a first substrate, a second substrate disposed to face the first substrate, a first organic film layered on the first substrate and having no orientation regulating force that regulates orientations of liquid crystal molecules, a second organic film layered on the second substrate and having no orientation regulating force that regulates the orientations of the liquid crystal molecules, and a liquid crystal layer disposed between the first organic film and the second organic film, the liquid crystal layer containing the multiple liquid crystal molecules arranged with major axes thereof oriented disorderly with respect to the first and second organic films.

A projection apparatus according to a second aspect of the present disclosure includes a light modulator configured to modulate incident light based on an image signal; a projection lens configured to project light output from the light modulator; and a polarization control apparatus disposed at a light exiting side of the light modulator in an optical path of the light output from the light modulator and to be projected by the projection lens, and configured to control a polarization state of the light modulated by the light modulator, the polarization control apparatus including a first substrate having a light incident surface on which light is incident, a second substrate disposed to face the first substrate, a first electrode disposed at a surface of the first substrate that is opposite the light incident surface, a first vertical orientation film layered on the first electrode and having no orientation regulating force that regulates orientations of liquid crystal molecules during voltage application, a second electrode disposed at a surface of the second substrate that faces the first substrate, a second vertical orientation film layered on the second electrode and having no orientation regulating force that regulates the orientations of the liquid crystal molecules during the voltage application, and a liquid crystal layer disposed between the first vertical orientation film and the second vertical orientation film, and containing the multiple liquid crystal molecules oriented randomly by the application of a voltage to the first and second electrodes.

An active state regulation apparatus according to a third aspect of the present disclosure includes: the projection apparatus according to first or second aspect described above; and a control apparatus configured to cause the projection apparatus to radiate linearly polarized light and non-polarized light separately to change an active state of a light receptor.

A polarization control apparatus according to a fourth aspect of the present disclosure includes: a first substrate; a second substrate disposed to face the first substrate; a first organic film layered on the first substrate and having no orientation regulating force that regulates orientations of liquid crystal molecules; a second organic film layered on the second substrate and having no orientation regulating force that regulates the orientations of the liquid crystal molecules; and a liquid crystal layer disposed between the first organic film and the second organic film and containing the liquid crystal molecules arranged with major axes thereof oriented disorderly with respect to the first and second organic films.

A polarization control apparatus according to a fifth aspect of the present disclosure includes: a first substrate; a second substrate disposed to face the first substrate; a first electrode provided at a surface of the first substrate that faces the second substrate; a first vertical orientation film layered on the first electrode and having no orientation regulating force that regulates orientations of liquid crystal molecules during voltage application; a second electrode disposed at a surface of the second substrate that faces the first substrate; a second vertical orientation film layered on the second electrode and having no orientation regulating force that regulates the orientations of the liquid crystal molecules during the voltage application, and

a liquid crystal layer disposed between the first vertical orientation film and the second vertical orientation film, and containing the liquid crystal molecules oriented randomly by the application of a voltage to the first and second electrodes.

A circadian rhythm control apparatus according to a sixth aspect of the present disclosure includes: a light source; the polarization control apparatus according to the fourth or fifth aspect described above, which is disposed in an optical path of light output from the light source and configured to control a polarization state of light that enters the polarization control apparatus; and a control apparatus configured to control the polarization control apparatus to cause the polarization control apparatus to output one of linearly polarized light and non-polarized light in accordance with a time zone.

### BRIEF DESCRIPTION OF THE DRAWINGS

FIG. 1 is a diagrammatic view showing the configuration of a projector in a first embodiment.

FIG. 2 is a cross-sectional view diagrammatically showing the configuration of a polarization control apparatus in the first embodiment.

FIG. 3 is a diagrammatic view showing an example of the orientations of liquid crystal molecules in the first embodiment.

FIG. 4 is a diagrammatic view showing the polarization state of output light for each liquid crystal cell in the first embodiment.

FIG. 5 is a diagrammatic view showing the polarization state of the output light for each liquid crystal cell in the first embodiment.

FIG. 6 is a cross-sectional view diagrammatically showing the configuration of a polarization control apparatus provided in a projector in a second embodiment.

FIG. 7 is a cross-sectional view diagrammatically showing the configuration of a polarization control apparatus provided in a projector in a third embodiment.

FIG. 8 is a cross-sectional view diagrammatically showing the configuration of the polarization control apparatus provided in the projector in the third embodiment.

FIG. 9 is a diagrammatic view showing a portion of the configuration of an image projection unit provided in a projector in a fourth embodiment.

FIG. 10 is a diagrammatic view showing a portion of the configuration of an image projection unit provided in a projector in a fifth embodiment.

FIG. 11 is a diagrammatic view showing the configuration of an active state regulation apparatus in a sixth embodiment.

FIG. 12 is a diagrammatic view showing the configuration of a circadian rhythm control apparatus according to a seventh embodiment.

### DESCRIPTION OF EMBODIMENTS

### First Embodiment

A first embodiment of the present disclosure will be described below with reference to the drawings.

### Schematic Configuration of Projector

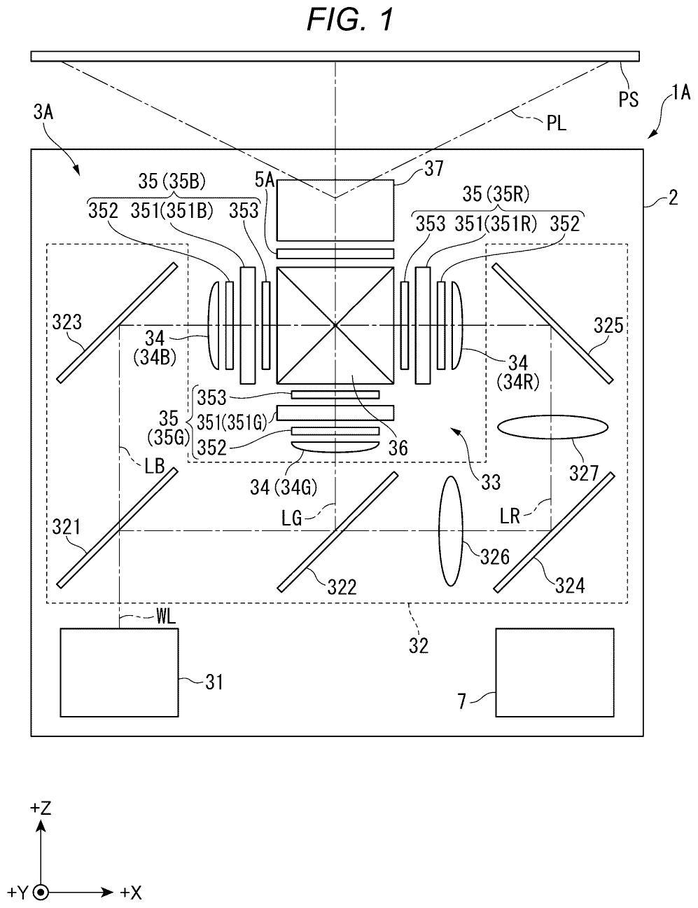

FIG. 1 is a diagrammatic view showing the configuration of a projector 1A according to the present embodiment.

The projector 1A according to the present embodiment is a projection apparatus that modulates light output from a light source 31 to form image light PL according to image information, enlarges the formed image light PL, and projects the enlarged image light PL onto a projection receiving surface PS such as a screen, as shown in FIG. 1. The projector 1A includes an exterior enclosure 2, an image projection unit 3A housed in the exterior enclosure 2, and a control section 7. Although not shown, the projector 1A also includes a cooling apparatus that cools cooling targets, and a power supply apparatus that supplies electronic components that constitute the projector 1A with electric power.

The control section 7 controls the image projection unit 3A. For example, in addition to controlling the light source 31 and light modulators 35, which constitute the image projection unit 3A, the control section 7 controls the operation of the polarization control apparatus 5A by applying a voltage to a polarization control apparatus 5A, which constitutes the image projection unit 3A.

### Configuration of Image Projecting Unit

The image projection unit 3A forms and projects the image light PL. The image projection unit 3A includes the light source 31, a color separator 32, an image forming apparatus 33, a projection lens 37, and the polarization control apparatus 5A.

It is assumed in the following description that the direction in which the light source 31 outputs illumination light WL is a +Z direction, and that the directions perpendicular to the +Z direction are a +X direction and a +Y direction. It is further assumed that the opposite direction of the +Z direction is a −Z direction, that the opposite direction of the +X direction is a −X direction, and that the opposite direction of the +Y direction is a −Y direction. It is still further assumed that an axis along the +Z direction is a Z-axis, that an axis along the +X direction is an X-axis, and that an axis along the +Y direction is a Y-axis.

### Configuration of Light Source

The light source 31 outputs the illumination light WL in the +Z direction. The configuration of the light source 31 can, for example, be a configuration including a solid-state light emitter and a wavelength converter that converts the wavelength of the light emitted from the solid-state light emitter. The configuration of the light source 31 can instead, for example, be a configuration including a discharge-type light emitting lamp such as an ultrahigh-pressure mercury lamp.

### Configuration of Color Separator

The color separator 32 separates the illumination light WL incident from the light source 31 into three types of color light, blue light LB, green light LG, and red light LR. The color separator 32 includes dichroic mirrors 321 and 322, total reflection mirrors 323, 324, and 325, and relay lenses 326 and 327.

Out of the illumination light WL incident from the light source 31, the dichroic mirror 321 transmits the blue light LB and reflects the green light LG and the red light LR in the +X direction.

Out of the green light LG and the red light LR separated by the dichroic mirror 321, the dichroic mirror 322 reflects the green light LG in the +Z direction and transmits the red light LR in the +X direction. The green light LG reflected off the dichroic mirror 322 enters a green light modulator 35G provided in the image forming apparatus 33.

The total reflection mirror 323 reflects the blue light LB having passed through the dichroic mirror 321 in the +X direction. The blue light LB reflected off the total reflection mirror 323 enters a blue light modulator 35B provided in the image forming apparatus 33.

The total reflection mirror 324 reflects the red light LR having passed through the dichroic mirror 322 in the +Z direction.

The total reflection mirror 325 reflects the red light LR reflected off the total reflection mirror 324 in the −X direction. The red light LR reflected off the total reflection mirror 325 enters a red light modulator 35R provided in the image forming apparatus 33.

The relay lens 326 is disposed between the dichroic mirror 322 and the total reflection mirror 324 in the optical path of the red light LR, and the relay lens 327 is disposed between the total reflection mirror 324 and the total reflection mirror 325 in the optical path of the red light LR. The relay lenses 326 and 327 compensate for the optical loss of the red light LR due to the fact that the optical path of the red light LR is longer than the optical path of the blue light LB and the optical path of the green light LG.

### Configuration of Image Forming Apparatus

The image forming apparatus 33 modulates the incident blue light LB, green light LG, and red color light LR separately from each other, and combines the modulated blue light LB, green light LG, and red light LR with one another to form the image light PL to be projected by the projection lens 37. The image forming apparatus 33 includes field lenses 34, the light modulators 35, and a light combiner 36.

### Configuration of Field Lenses

The field lenses 34 each parallelize incident light. The image forming apparatus 33 includes three field lenses 34. The three field lenses 34 include a field lens 34B provided in the optical path of the blue light LB, a field lens 34G provided in the optical path of the green light LG, and a field lens 34R provided in the optical path of the red light LR. The blue light LB, the green light LG, and the red light LR having passed through the field lenses 34R, 34G, and 34B enter the light modulators 35 provided in accordance with the colors.

### Configuration of Light Modulators

The light modulators 35 modulate the three types of color light output from the light source 31 in accordance with image information, and output the modulated three types of color light to the light combiner 36. The light modulators 35 include the blue light modulator 35B, which modulates the blue light LB, the green light modulator 35G, which modulates the green light LG separated by the color separator 32, and the red light modulator 35R, which modulates the red light LR.

The light modulators 35 each include a light modulation module 351, a light-incident-side polarizer plate 352, and a light-exiting-side polarizer plate 353.

Specifically, the blue light modulator 35B includes a blue light modulation module 351B, which modulates the blue light LB, the light-incident-side polarizer plate 352 disposed at the light incident side of the blue light modulation module 351B, and the light-exiting-side polarizer plate 353 disposed at the light exiting side of the blue light modulation module 351B. The blue light modulator 35B outputs the modulated blue light in the +X direction.

The green light modulator 35G includes a green light modulation module 351G, which modulates the green light LG, the light-incident-side polarizer plate 352, and the light-exiting-side polarizer plate 353. The green light modulator 35G outputs the modulated green light in the +Z direction.

The red light modulator 35R includes a red light modulation module 351R, which modulates the red light LR, the light-incident-side polarizer plate 352, and the light-exiting-side polarizer plate 353. The red light modulator 35R outputs the modulated red light in the −X direction.

Note in the present embodiment that the light modulation modules 351 are each configured with a liquid crystal panel, and the light modulators 35 are each a liquid crystal light valve including the light modulation module 351, the light-incident-side polarizer plate 352, and the light-exiting-side polarizer plate 353. The light-exiting-side polarizer plate 353 of each of the light modulators 35 is a polarizer disposed with respect to the polarization control apparatus 5A, which will be described later, to be located at the light incident side of the polarization control apparatus 5A.

### Configuration of Light Combiner

The light combiner 36 combines the blue light incident from the blue light modulator 35B, the green light incident from the green light modulator 35G, and the red light incident from the red light modulator 35R with one another to form the image light PL, and outputs the formed image light PL toward the polarization control apparatus 5A. That is, the light combiner 36 outputs the image light PL to the projection lens 37 via the polarization control apparatus 5A.

In the present embodiment, the light combiner 36 is configured with a cross dichroic prism having a substantially cuboidal shape, but not necessarily. The light combiner 36 may instead be configured with multiple dichroic mirrors.

### Configuration of Projection Lens

The projection lens 37 projects the image light PL incident from the light combiner 36 of the image forming apparatus 33 via the polarization control apparatus 5A onto the projection receiving surface PS. Although not shown, the projection lens 37 may, for example, be a lens assembly having multiple lenses and a lens barrel that holds the multiple lenses.

### Configuration of Polarization Control Apparatus

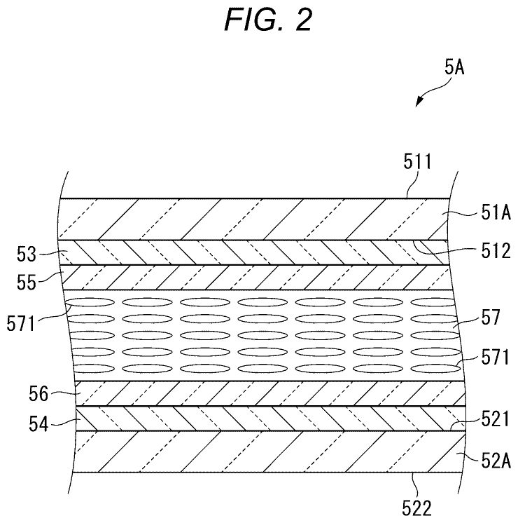

FIG. 2 is a cross-sectional view diagrammatically showing the configuration of the polarization control apparatus 5A. FIG. 2 shows that multiple liquid crystal molecules 571 are all oriented along the rightward-leftward direction in FIG. 2. In practice, however, the multiple liquid crystal molecules 571 are randomly oriented in a plane perpendicular to a first substrate 51A and a second substrate 52A. For example, the multiple liquid crystal molecules 571 are randomly oriented in a plane perpendicular to a light incident surface 511 of the first substrate 51A and including a depth direction toward the plane of view of FIG. 2.

The polarization control apparatus 5A controls the polarization state of the image light PL incident from the image forming apparatus 33 to output non-polarized image light PL. In the present embodiment, the polarization control apparatus 5A is disposed between the light combiner 36 and the projection lens 37 of the image forming apparatus 33 in the optical path of the image light PL output from the image forming apparatus 33, but not necessarily. The polarization control apparatus 5A may instead be disposed at the light exiting side of the projection lens 37 in the optical path of the image light PL. That is, the polarization control apparatus 5A is disposed at the light exiting side of the light modulators 35 in the optical path of the image light PL output from the light modulators 35 and projected by the projection lens 37.

The polarization control apparatus 5A includes the first substrate 51A, the second substrate 52A, a first electrically conductive layer 53, a second electrically conductive layer 54, a first organic film 55, a second organic film 56, and a liquid crystal layer 57, as shown in FIG. 2.

In the following description, light that is linearly polarized is referred to as linearly polarized light, light that is not polarized is referred to as non-polarized light, and light that is circularly polarized is referred to as circularly polarized light. Out of the linearly polarized light, light having s-polarization is referred to as s-polarized light, and light having p-polarization is referred to as p-polarized light.

### Configuration of First and Second Substrates

Each of the first substrate 51A and the second substrate 52A is a light transmissive substrate, and is a glass substrate in the present embodiment. The first substrate 51A and the second substrate 52A are disposed to face each other in the traveling direction of the image light PL that enters the polarization control apparatus 5A.

The first substrate 51A has the light incident surface 511 and a light exiting surface 512.

The light incident surface 511 is a surface of the first substrate 51A on which the image light PL is incident. The light incident surface 511 is a surface of the first substrate 51A that is opposite the light exiting surface 512, which faces the second substrate 52A.

The light exiting surface 512 is a surface of the first substrate 51A via which the image light PL exits and which faces the second substrate 52A. The first electrically conductive layer 53 is formed at the light exiting surface 512.

The second substrate 52A is disposed to face the first substrate 51A. The second substrate 52A has a light incident surface 521 and a light exiting surface 522.

The light incident surface 521 is a surface of the second substrate 52A that faces the first substrate 51A, and is a surface of the second substrate 52A on which the image light PL is incident. The second electrically conductive layer 54 is formed at the light incident surface 521.

The light exiting surface 522 is a surface of the second substrate 52A via which the image light PL exits. The light exiting surface 522 is a surface of the second substrate 52A that is opposite the light incident surface 521.

### Configuration of First and Second Electrically Conductive Layers

The first electrically conductive layer 53 and the second electrically conductive layer 54 are each an ITO electrode layer.

The first electrically conductive layer 53 is formed at the light exiting surface 512 of the first substrate 51A. The first electrically conductive layer 53 is disposed between the first substrate 51A and the first organic film 55 and layered thereon. The first electrically conductive layer 53 constitutes a first electrode electrically coupled to the control section 7.

The second electrically conductive layer 54 is formed at the light incident surface 521 of the second substrate 52A. The second electrically conductive layer 54 is disposed between the second substrate 52A and the second organic film 56 and layered thereon. The second electrically conductive layer 54 constitutes a second electrode electrically coupled to the control section 7.

The control section 7 can therefore apply a voltage to the first electrically conductive layer 53 and the second electrically conductive layer 54 to apply the voltage to the liquid crystal layer 57 via the first electrode configured with the first electrically conductive layer 53 and the second electrode configured with the second electrically conductive layer 54. Instead, the first electrically conductive layer 53 and the second electrically conductive layer 54 may not be coupled to the control section 7.

As described above, unlike a typical liquid crystal panel having pixel electrodes that specify pixels and a common electrode, the first electrically conductive layer 53 and the second electrically conductive layer 54 do not specify a pixel specified by a transistor or the like provided in each of the pixel electrodes in the typical liquid crystal panel.

### Configuration of First and Second Organic Films

The first organic film 55 is formed at the first electrically conductive layer 53 layered on the light exiting surface 512 of the first substrate 51A. That is, the first organic film 55 is layered indirectly on the first substrate 51A.

The second organic film 56 is formed at the second electrically conductive layer 54 layered on the light incident surface 521 of the second substrate 52A. That is, the second organic film 56 is layered indirectly on the second substrate 52A.

The first organic film 55 and the second organic film 56 in contact with the liquid crystal layer 57 are each a polyimide film having been subjected to no rubbing treatment. The first organic film 55 and the second organic film 56 each therefore have no orientation regulating force that regulates the orientations of the liquid crystal molecules. That is, the first organic film 55 and the second organic film 56 have no orientation regulating force that orients the liquid crystal molecules in one direction to align the orientations of the liquid crystal molecules with each other.

### Configuration of Liquid Crystal Layer

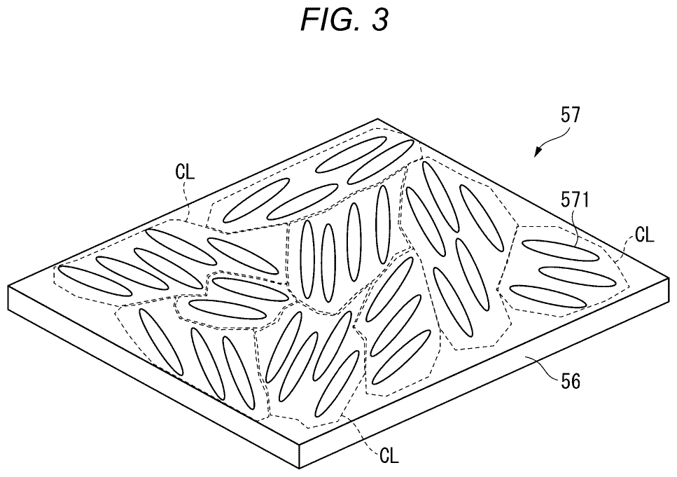

FIG. 3 is a diagrammatic view showing an example of the orientations of the liquid crystal molecules in the liquid crystal layer 57.

The liquid crystal layer 57 is disposed between and encapsulated by the first substrate 51A and the second substrate 52A. In detail, the liquid crystal layer 57 is disposed between the first organic film 55 layered on the light exiting surface 512 of the first substrate 51A and the second organic film 56 layered on the light incident surface 521 of the second substrate 52A. The liquid crystal layer 57 contains the multiple liquid crystal molecules 571.

The first organic film 55 and the second organic film 56, which sandwich the liquid crystal layer 57, each have no orientation regulating force, as described above. The multiple liquid crystal molecules 571, which constitute the liquid crystal layer 57, therefore have random orientations, as shown in FIG. 3. For example, the multiple liquid crystal molecules 571 are randomly oriented in a plane perpendicular to the first substrate 51A or the second substrate 52A, as described above.

Liquid crystal cells CL, in each of which liquid crystal molecules 571 are present in the liquid crystal layer 57, are microscopic single-orientation regions created by the fact that the first organic film 55 and the second organic film 56 have been subjected to no orientation treatment. The liquid crystal cells CL surrounded by the dotted lines shown in FIG. 3 therefore each do not necessarily have a rectangular shape, and the liquid crystal cells CL also have different sizes.

The liquid crystal molecules 571 described above are negative nematic liquid crystal molecules. That is, the refractive index of the liquid crystal molecule 571 in the major axis direction thereof is smaller than the refractive index of the liquid crystal molecule 571 in the direction perpendicular to the major axis. In other words, the refractive index of the liquid crystal molecules 571 in the minor axis direction thereof is greater than the refractive index of the liquid crystal molecules 571 in the major axis direction.

### Effects of Polarization Control Apparatus

The multiple liquid crystal molecules 571, which constitute the liquid crystal layer 57 of the polarization control apparatus 5A, are so arranged that the major axis directions of the liquid crystal molecules 571 are oriented randomly, as described above. That is, the liquid crystal molecules 571 are so arranged that the major axes thereof are oriented disorderly.

Retardations are therefore disorderly imparted to the light passing through the liquid crystal layer 57. The linearly polarized image light PL output from each of the light-exiting-side polarizer plates 353 and entering the polarization control apparatus 5A from the light combiner 36 passes through the polarization control apparatus 5A, which produces random non-polarized light having a low degree of polarization. The image light PL projected from the projector 1A is therefore more random non-polarized light.

The polarization control apparatus 5A can output non-polarized light without application of a voltage to the liquid crystal layer 57 via the first electrically conductive layer 53 and the second electrically conductive layer 54, as described above. Therefore, unlike a typical liquid crystal panel, it is not necessary to configure one of the first electrically conductive layer 53 and the second electrically conductive layer 54 as pixel electrodes and configure the other electrically conductive layer as a common electrode. That is, it is not necessary to form the pixel electrodes by using one of the first electrically conductive layer 53 and the second electrically conductive layer 54. Therefore, in the present embodiment, the first electrode configured with the first electrically conductive layer 53 and the second electrode configured with the second electrically conductive layer 54 are each a common electrode. The configuration of the polarization control apparatus 5A is thus simplified.

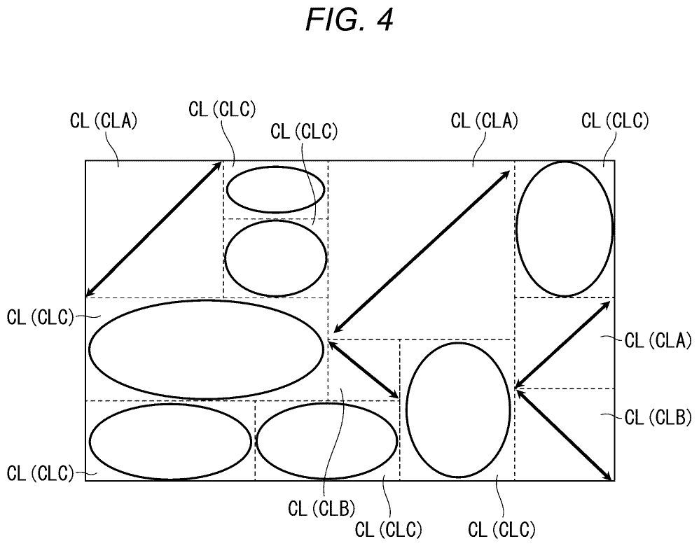

FIG. 4 is a diagrammatic view showing the polarization state of the output light for each of the liquid crystal cells CL in a certain orientation state of the liquid crystal molecules 571.

In FIG. 4, the liquid crystal cells CL each have a rectangular shape for convenience, but the actual multiple liquid crystal cells CL have shapes different from one another, as shown in FIG. 3. The multiple liquid crystal cells CL also have sizes different from one another.

In FIG. 4, a liquid crystal cell CLA, in which an arrow is drawn, indicates a liquid crystal cell CL that outputs s-polarized light, which is linearly polarized light, and a liquid crystal cell CLB, in which an arrow is drawn, indicates a liquid crystal cell CL that outputs p-polarized light, which is linearly polarized light. A liquid crystal cell CLC, in which an ellipse is drawn, indicates a liquid crystal cell CL that outputs elliptically polarized light. The size of the ellipse drawn in the liquid crystal cell CLC indicates that the output elliptically polarized light has a different polarization axis.

Therefore, out of the multiple liquid crystal cells CL, the liquid crystal cell CLA can output s-polarized light, the liquid crystal cell CLB can output p-polarized light, and the liquid crystal cell CLC can output elliptically polarized light having a different polarization axe, as shown, for example, in FIG. 4.

The polarization control apparatus 5A can thus output non-polarized light.

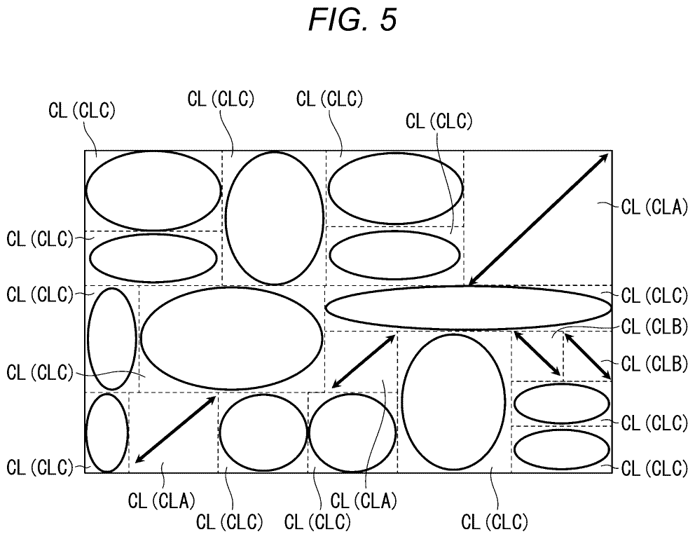

FIG. 5 is a diagrammatic view showing the polarization state of the output light for each of the liquid crystal cells CL in another orientation state of the liquid crystal molecules 571. That is, FIG. 5 is a diagrammatic view showing the polarization state of the output light for each of the liquid crystal cells CL in an orientation state different from that in FIG. 4.

The control section 7 can change the orientations of the liquid crystal molecules 571, which constitute the liquid crystal layer 57, by changing the voltage applied to the liquid crystal cells CL. The liquid crystal cell CLA, which outputs s-polarized light, the liquid crystal cell CLB, which outputs p-polarized light, and the liquid crystal cell CLC, which outputs elliptically polarized light, can therefore have different positions and sizes, as shown, for example, in FIG. 5.

The positions and sizes of the liquid crystal cells CLA, CLB, and CLC can then be changed by temporally changing the voltage applied from the control section 7 to the liquid crystal cells CL.

The polarization control apparatus 5A can thus output temporally and spatially random non-polarized light.

### Advantages of First Embodiment

The projector 1A according to the present embodiment described above provides the advantages below.

The projector 1A corresponds to the projection apparatus. The projector 1A includes the light modulators 35, the projection lens 37, and the polarization control apparatus 5A.

The light modulators 35 each modulate incident light based on an image signal.

The projection lens 37 projects the light output from the light modulators 35.

The polarization control apparatus 5A is disposed at the light exiting side of the light modulators 35 in the optical path of the image light PL output from the light modulators 35 and to be projected by the projection lens 37, and controls the polarization state of the image light PL modulated by the light modulators 35.

The polarization control apparatus 5A includes the first substrate 51A, the second substrate 52A, the first organic film 55, the second organic film 56, and the liquid crystal layer 57.

The second substrate 52A is disposed to face the first substrate 51A.

The first organic film 55 is layered on the first substrate 51A via the first electrically conductive layer 53. The first organic film 55 has no orientation regulating force that regulates the orientations of the liquid crystal molecules.

The second organic film 56 is layered on the second substrate 52A via the second electrically conductive layer 54. The second organic film 56 has no orientation regulating force that regulates the orientations of the liquid crystal molecules.

The liquid crystal layer 57 is disposed between the first organic film 55 and the second organic film 56. That is, the liquid crystal layer 57 is disposed between and encapsulated by the first organic film 55 and the second organic film 56. The liquid crystal layer 57 contains the multiple liquid crystal molecules arranged with the major axis thereof are oriented disorderly with respect to the first organic film 55 and the second organic film 56.

According to the configuration described above, in the polarization control apparatus, the first and second organic films each have no orientation regulating force that regulates the orientations of the liquid crystal molecules. For example, the first and second organic films have been subjected to no rubbing treatment. The liquid crystal molecules are therefore arranged with the major axes thereof oriented disorderly in the liquid crystal layer disposed between the first and second organic films. Since the modulated light modulated by the light modulators passes through the thus configured polarization control apparatus, retardations are disorderly imparted to the modulated light when the modulated light passes through the liquid crystal layer. The modulated light output from the polarization control apparatus is therefore random non-polarized light having a low degree of polarization. The light projected from the projection apparatus can therefore be light having a more random polarization state.

In the projector 1A, the polarization control apparatus 5A includes the first electrically conductive layer 53 and the second electrically conductive layer 54.

The first electrically conductive layer 53 is disposed between the first substrate 51A and the first organic film 55.

The second electrically conductive layer 54 is disposed between the second substrate 52A and the second organic film 56.

According to the configuration described above, in which the first electrically conductive layer 53 and the second electrically conductive layer 54 are formed, the multiple liquid crystal molecules can be readily arranged disorderly. In addition, when the first organic film 55 and the second organic film 56 are formed, the uniformity of each of the organic films 55 and 56 can be readily secured.

The projector 1A includes the control section 7, which applies a voltage to the liquid crystal layer 57.

The first electrically conductive layer constitutes the first electrode electrically coupled to the control section, and the second electrically conductive layer constitutes the second electrode electrically coupled to the control section.

According to the configuration described above, the control section can change the orientation angle of each of the liquid crystal molecules by applying a voltage to the liquid crystal layer via the first electrode configured with the first electrically conductive layer and the second electrode configured with the second electrically conductive layer. That is, the control section can change the orientation angle of each of the liquid crystal molecules by applying a voltage to the liquid crystal layer. The degree of polarization of the light output from the polarization control apparatus can therefore be regulated.

In the projector 1A, the liquid crystal molecules 571 are negative nematic liquid crystal molecules.

According to the configuration described above, when the liquid crystal molecules 571 are so arranged that the major axis directions of the liquid crystal molecules 571 are along the organic films 55 and 56, retardations are readily imparted to the light passing through the liquid crystal molecules 571. The polarization control apparatus 5A can therefore readily form random non-polarized light.

### Second Embodiment

A second embodiment of the present disclosure will next be described.

A projector according to the present embodiment has the same configuration as the projector 1A according to the first embodiment, but differs therefrom in the configuration of the polarization control apparatus. In the following description, portions that are the same or substantially the same as the portions having been already described have the same reference characters and will not be described.

### Schematic Configuration of Projector

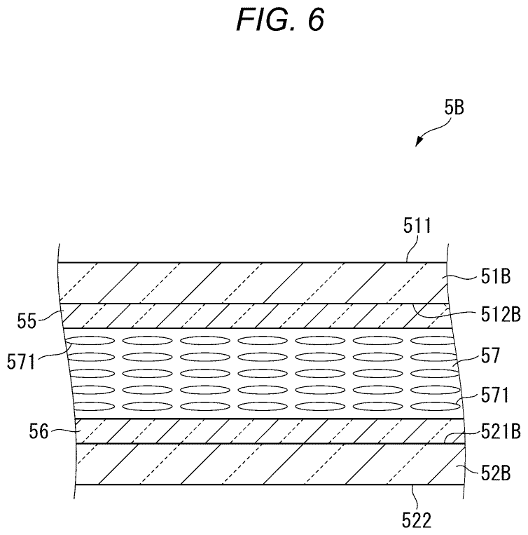

FIG. 6 is a diagrammatic view showing the configuration of a polarization control apparatus 5B provided in the projector according to the present embodiment.

The projector according to the present embodiment has the same configurations and functions as the projector 1A according to the first embodiment except that the polarization control apparatus 5A is replaced with the polarization control apparatus 5B shown in FIG. 6. That is, the image projection unit 3A according to the present embodiment includes the polarization control apparatus 5B in place of the polarization control apparatus 5A according to the first embodiment.

### Configuration of Polarization Control Apparatus

The polarization control apparatus 5B controls the polarization state of incident light to output non-polarized light, as the polarization control apparatus 5A. The polarization control apparatus 5B has the same configurations and functions as the polarization control apparatus 5A except that the first substrate 51A, the second substrate 52A, the first electrically conductive layer 53, and the second electrically conductive layer 54 are replaced with a first substrate 51B and a second substrate 52B, as shown in FIG. 4. That is, the polarization control apparatus 5B includes the first substrate 51B, the second substrate 52B, the first organic film 55, the second organic film 56, and the liquid crystal layer 57.

### Configuration of First and Second Substrates

The first substrate 51B is a light transmissive substrate, as the first substrate 51A. The first substrate 51B has the light incident surface 511 and a light exiting surface 512B.

The light exiting surface 512B is a surface of the first substrate 51B which is opposite the light incident surface 511 and via which the light having passed through the first substrate 51B exits. That is, the light exiting surface 512B is a surface facing the first organic film 55.

The second substrate 52B is a light transmissive substrate, as the second substrate 52A. The second substrate 52B has a light incident surface 521B and the light exiting surface 522.

The light incident surface 521B is a surface of the second substrate 52B which faces the first substrate 51B and on which the light from the liquid crystal layer 57 is incident.

The light exiting surface 512B of the first substrate 51B and the light incident surface 521B of the second substrate 52B have each been subjected to a surface activation treatment. That is, the light exiting surface 512B is a first surface-activated surface, and the light incident surface 521B is a second surface-activated surface. The surface activation treatment may, for example, be an O₂ plasma treatment.

In the present embodiment, the first organic film 55 is layered on the light exiting surface 512B of the first substrate 51B, and the second organic film 56 is layered on the light incident surface 521B of the second substrate 52B. The organic films 55 and 56 can each be configured with a polyimide film, as described above. Note also in the present embodiment that the organic films 55 and 56 have been subjected to no rubbing treatment. That is, the organic films 55 and 56 each have no orientation regulating force that regulates the orientations of the liquid crystal molecules.

### Advantages of Second Embodiment

The projector according to the present embodiment described above provides the following advantages as well as the same advantages provided by the projector 1A according to the first embodiment.

In the projector as the projection apparatus according to the present embodiment, the light exiting surface 512B of the first substrate 51B is the first surface-activated surface, and the first organic film 55 is provided at the first surface-activated surface. The light exiting surface 512B is a surface of the first substrate 51B that faces the first organic film 55.

The light incident surface 521B of the second substrate 52B is the second surface-activated surface, and the second organic film 56 is provided at the second surface-activated surface. The light incident surface 521B is a surface on the second substrate 52B that faces the second organic film 56.

According to the configuration described above, the multiple liquid crystal molecules 571 can be readily arranged disorderly without providing the first substrate 51B with the first electrically conductive layer 53 and without providing the second substrate 52B with the second electrically conductive layer 54.

### Third Embodiment

A third embodiment of the present disclosure will next be described.

A projector according to the present embodiment has the same configuration as the projector 1A according to the first embodiment, but differs therefrom in the configuration of the polarization control apparatus. In the following description, portions that same or substantially the same as the portions having been already described have the same reference characters and will not be described.

### Schematic Configuration of Projector

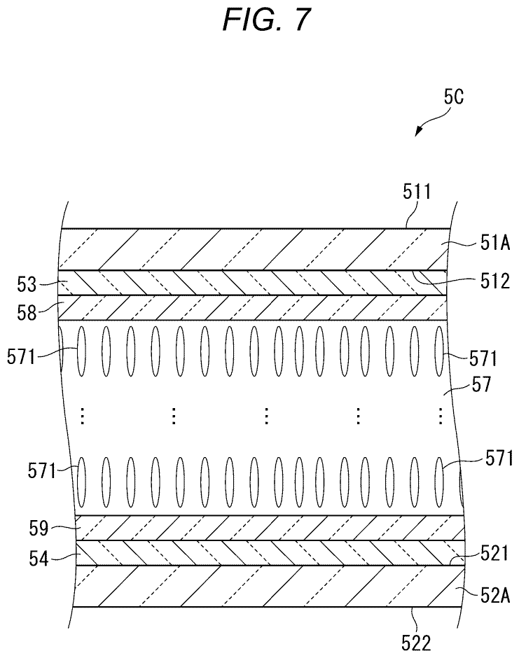

FIG. 7 is a diagrammatic view showing the configuration of a polarization control apparatus 5C provided in a projector according to the present embodiment.

The projector according to the present embodiment has the same configurations and functions as the projector 1A according to the first embodiment except that the polarization control apparatus 5A is replaced with the polarization control apparatus 5C shown in FIG. 7. That is, the image projection unit 3A according to the present embodiment includes the polarization control apparatus 5C in place of the polarization control apparatus 5A.

The polarization control apparatus 5C is disposed between the light combiner 36 and the projection lens 37 in the optical path of the image light PL, and may instead be disposed with respect to the projection lens 37 to be located at the light exiting side of the projection lens 37.

### Configuration of Polarization Control Apparatus

The polarization control apparatus 5C controls the polarization state of the incident image light PL to output non-polarized image light PL, as the polarization control apparatuses 5A and 5B described above. The polarization control apparatus 5C has the same configurations and functions as the polarization control apparatus 5A according to the first embodiment except that the first organic film 55 and the second organic film 56 are replaced with a first vertical orientation film 58 and a second vertical orientation film 59. That is, the polarization control apparatus 5C includes the first substrate 51A, the second substrate 52A, the first electrically conductive layer 53, the second electrically conductive layer 54, the liquid crystal layer 57, the first vertical orientation film 58, and the second vertical orientation film 59.

Note in the present embodiment that the first electrically conductive layer 53 and the second electrically conductive layer 54 are electrically coupled to the control section 7.

### Configurations of First and Second Vertical Orientation Films

The first vertical orientation film 58 is layered on the first electrically conductive layer 53 formed at the light exiting surface 512 of the first substrate 51A, and is in contact with the liquid crystal layer 57. That is, the first vertical orientation film 58 is indirectly layered on the light exiting surface 512 of the first substrate 51A.

The second vertical orientation film 59 is layered on the second electrically conductive layer 54 formed at the light incident surface 521 of the second substrate 52A, and is in contact with the liquid crystal layer 57. That is, the second vertical orientation film 59 is indirectly layered on the light incident surface 521 of the second substrate 52A.

The vertical orientation films 58 and 59 are each an inorganic vertical orientation thin film made of an inorganic material such as SiO₂. In detail, the first vertical orientation film 58 can be formed by depositing the inorganic material to form a film at the first electrically conductive layer 53 by using a film formation method such as chemical vapor deposition (CVD), physical vapor deposition (PVD), or ion beam sputtering. The first vertical orientation film 58 has a columnar structure, and the first vertical orientation film 58, when formed, desirably grows in the direction perpendicular to the first substrate 51A. The same applies to the second vertical orientation film 59 to be indirectly layered on the second substrate 52A.

The vertical orientation films 58 and 59 each has no orientation regulating force that regulates in a specific direction the liquid crystal molecules 571 to which a voltage is applied via the first electrically conductive layer 53 and the second electrically conductive layer 54. In detail, the vertical orientation films 58 and 59 each have no orientation regulating force that regulates the orientations of the liquid crystal molecules 571 when a voltage is applied to the liquid crystal layer 57. That is, the vertical orientation films 58 and 59 each have no orientation regulating force that regulates the orientations of the liquid crystal molecules 571 at the time of the application of the voltage. Therefore, in the state where the voltage is applied to the liquid crystal layer 57, the multiple liquid crystal molecules 571 are so arranged that the major axes thereof are oriented randomly.

Also in the present embodiment, the multiple liquid crystal molecules 571 include, for example, one or more kinds of nematic liquid crystal molecules, and are liquid crystal molecules having permittivity anisotropy.

### Effects of Polarization Control Apparatus

In the state where no voltage is applied to the liquid crystal layer 57, the multiple liquid crystal molecules 571, which constitute the liquid crystal layer 57, are so oriented by the first vertical orientation film 58 and the second vertical orientation film 59 that the major axis directions of the liquid crystal molecules 571 are perpendicular or substantially perpendicular to the substrates 51A and 52A. When the linearly polarized image light PL enters the polarization control apparatus 5C containing the liquid crystal molecules 571 oriented as described above, the image light PL is output from the polarization control apparatus 5C with the polarization state of the image light PL substantially unchanged. That is, the linearly polarized image light PL having entered the polarization control apparatus 5C is output therefrom still as the linearly polarized light.

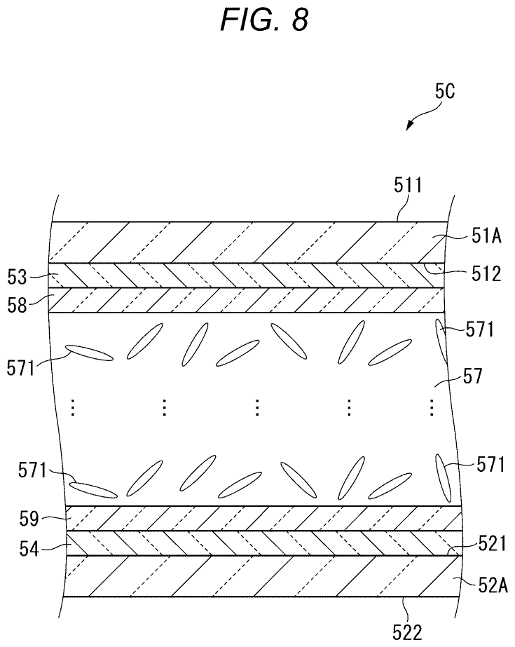

FIG. 8 is a diagrammatic view showing the configuration of the polarization control apparatus 5C and the orientation state of the liquid crystal molecules 571 in the state in which a voltage is applied to the liquid crystal layer 57.

On the other hand, when a voltage is applied to the liquid crystal layer 57 via the first electrically conductive layer 53 and the second electrically conductive layer 54, the multiple liquid crystal molecules 571, which constitute the liquid crystal layer 57, are so oriented that the major axes of the liquid crystal molecules 571 are oriented randomly. Retardations corresponding to the orientation angles of the liquid crystal molecules 571 are therefore imparted to the light passing through the liquid crystal molecules 571. That is, retardations are imparted disorderly to the light passing through the liquid crystal layer 57. The image light PL output from the polarization control apparatus 5C is therefore random non-polarized image light PL having a small degree of polarization.

As described above, the control section 7 coupled to the first electrically conductive layer 53 and the second electrically conductive layer 54 controls the state of the application of the voltage to the liquid crystal layer 57 to control the polarization state of the image light PL to be output from the polarization control apparatus 5C. When the control section 7 applies no voltage to the liquid crystal layer 57, the linearly polarized image light PL can be output from the polarization control apparatus 5C, and when the control section 7 applies a voltage to the liquid crystal layer 57, the non-polarized image light PL can be output from the polarization control apparatus 5C. The projector according to the present embodiment can thus project the linearly polarized image light PL or the non-polarized image light PL.

### Advantages of Third Embodiment

The projector according to the present embodiment described above provides the advantages below.

The projector according to the present embodiment corresponds to the projection apparatus. The projector includes the light modulators 35, the projection lens 37, and the polarization control apparatus 5C.

The light modulators 35 each modulate incident light based on an image signal.

The projection lens 37 projects the light output from the light modulators 35.

The polarization control apparatus 5C is disposed at the light exiting side of the light modulator 35 in the optical path of the image light PL output from the light modulator 35 and to be projected by the projection lens 37, and controls the polarization state of the image light PL modulated by the light modulators 35.

The polarization control apparatus 5C includes the first substrate 51A, the second substrate 52A, the first electrically conductive layer 53, the second electrically conductive layer 54, the first vertical orientation film 58, the second vertical orientation film 59, and the liquid crystal layer 57.

The first substrate 51A has the light incident surface 511, on which the image light PL is incident.

The second substrate 52A is disposed to face the first substrate 51A.

The first electrically conductive layer 53 constitutes the first electrode. The first electrically conductive layer 53 is disposed at the light exiting surface 512 of the first substrate 51A that is opposite the light incident surface 511.

The first vertical orientation film 58 is layered on the first electrically conductive layer 53. The first vertical orientation film 58 has no orientation regulating force that regulates the orientations of the liquid crystal molecules 571 when a voltage is applied to the liquid crystal layer 57.

The second electrically conductive layer 54 constitutes the second electrode. The second electrically conductive layer 54 is disposed at the light incident surface 521 of the second substrate 52A. The light incident surface 521 is a surface of the second substrate 52A that faces the first substrate 51A.

The second vertical orientation film 59 is layered on the second electrically conductive layer 54. The second vertical orientation film 59 has no orientation regulating force that regulates the orientations of the liquid crystal molecules 571 when a voltage is applied to the liquid crystal layer 57.

The liquid crystal layer 57 is disposed between the first vertical orientation film 58 and the second vertical orientation film 59. The liquid crystal layer 57 contains the multiple liquid crystal molecules 571, which are randomly oriented by application of a voltage to each of the first electrode configured with the first electrically conductive layer 53 and the second electrode configured with the second electrically conductive layer 54.

According to the configuration described above, the image light PL to be projected can be random non-polarized light, as in the projector 1A according to the first embodiment.

That is, when no voltage is applied to the liquid crystal layer 57, the vertical orientation films 58 and 59 orient the liquid crystal molecules 571 perpendicularly to the vertical orientation films 58 and 59. On the other hand, when a voltage is applied to the liquid crystal layer 57, the multiple liquid crystal molecules 571 tilt in random directions with respect to an imaginary plane parallel to each of the vertical orientation films 58 and 59. Since the image light PL modulated by the light modulators 35 passes through the thus configured polarization control apparatus 5C, retardations are imparted disorderly to the image light PL when the image light PL passes through the liquid crystal layer 57. The image light PL output from the polarization control apparatus 5C is therefore random non-polarized light having a small degree of polarization. The light projected from the projector can therefore be light having a more random polarization state.

### Fourth Embodiment

A fourth embodiment of the present disclosure will next be described.

The projector according to the present embodiment differs from the projector 1A according to the first embodiment in that a light-incident-side retardation element provided at the light incident side of the polarization control apparatus and a light-exiting-side retardation element provided at the light exiting side of the polarization control apparatus are provided in addition to the configuration of the projector 1A. In the following description, portions that are the same or substantially the same as the portions having been already described have the same reference characters and will not be described.

### Schematic Configurations of Projector and Image Projection Unit

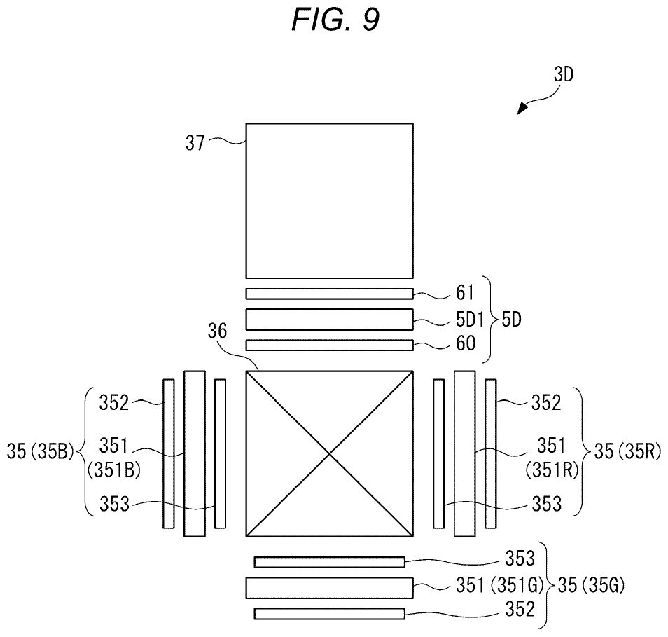

FIG. 9 is a diagrammatic view showing a portion of the configuration of an image projection unit 3D provided in the projector according to the present embodiment.

The projector according to the present embodiment has the same configurations and functions as the projector according to the third embodiment except that the image projection unit 3A is replaced with the image projection unit 3D, a portion of the configuration of which is shown in FIG. 7.

The image projection unit 3D has the same components and functions as the image projection unit 3A according to the third embodiment except that the polarization control apparatus 5A is replaced with a polarization control apparatus 5D. That is, the image projection unit 3D includes the light source 31, the color separator 32, the image forming apparatus 33, the projection lens 37, and the polarization control apparatus 5D.

### Configuration of Polarization Control Apparatus

The polarization control apparatus 5D has the same configurations and functions as the polarization control apparatus 5C according to the third embodiment except that the polarization control apparatus 5D further includes a light-incident-side retardation element 60 and a light-exiting-side retardation element 61.

The polarization control apparatus 5D includes an apparatus body 5D1 configured in the same manner as that of the polarization control apparatus 5C, the light-incident-side retardation element 60, and the light-exiting-side retardation element 61.

The polarization control apparatus 5D is disposed between the light combiner 36 and the projection lens 37 in the optical path of the image light PL, and may instead be disposed with respect to the projection lens 37 to be located at the light exiting side of the projection lens 37.

### Configuration of Light-Incident-Side Retardation Element

The light-incident-side retardation element 60 is provided between the light-exiting-side polarizer plate 353 of each of the light modulators 35 and the apparatus body 5D1 in the optical path of the image light PL. That is, the light-incident-side retardation element 60 is disposed with respect to the apparatus body 5D1 to be located at the light incident side of the polarization control apparatus 5D.

The light-incident-side retardation element 60 imparts retardations to the linearly polarized image light PL output from each of the light-exiting-side polarizer plates 353 and incident from the light combiner 36. In the present embodiment, the light-incident-side retardation element 60 is a λ/4 retardation film, and the light-incident-side retardation element 60 converts the incident linearly polarized image light PL into circularly polarized image light PL and outputs the circularly polarized image light PL.

When linearly polarized light enters the apparatus body 5D1 configured in the same manner as that of the polarization control apparatus 5C, the light passing through and output from the apparatus body 5D1 tends to be non-polarized light biased to one of the s-polarized light and the p-polarized light, which are each linearly polarized light. Specifically, the apparatus body 5D1 has in some cases a region where the liquid crystal molecules are oriented in the same direction as the vibration direction of the linearly polarized light that enters the apparatus body 5D1. When the linearly polarized light passes through the region, the light passing therethrough is not converted into non-polarized light but is output with the polarization state thereof unchanged. That is, the region where the liquid crystal molecules are oriented in the same direction as the vibration direction of the incident linearly polarized light does not change the polarization state of the incident light but outputs linearly polarized light having the same polarization state. In this case, the non-polarized light output from the apparatus body 5D1 tends to be light containing the s-polarized light and the p-polarized light with the amount of one of the two types of linearly polarized light being greater than the amount of the other.

In contrast, in the present embodiment, the light-incident-side retardation element 60 is provided between each of the light-exiting-side polarizer plates 353 and the apparatus body 5D1, and the light-incident-side retardation element 60 converts the incident linearly polarized image light PL into the circularly polarized image light PL by imparting retardations to the image light PL.

The light entering the apparatus body 5D1 is converted into circularly polarized light by the thus configured light-incident-side retardation element 60 regardless of the region of the apparatus body 5D1 via which the light enters. The apparatus body 5D1 can therefore impart retardations according to the orientations of the liquid crystal molecules 571 to the incident circularly polarized image light PL, and can output more random non-polarized image light PL.

### Configuration of Light-Exiting-Side Retardation Element

The light-exiting-side retardation element 61 is disposed with respect to the apparatus body 5D1 to be located at the light exiting side of the polarization control apparatus 5D. In the present embodiment, the light-exiting-side retardation element 61 is disposed between the apparatus body 5D1 and the projection lens 37 in the optical path of the image light PL. The light-exiting-side retardation element 61 imparts retardations to the image light PL incident from the apparatus body 5D1.

The light-exiting-side retardation element 61 can be configured, for example, with a λ/4 retardation film. In this case, when no voltage is applied to the liquid crystal layer 57 of the apparatus body 5D1 and the circularly polarized image light PL is incident from the apparatus body 5D1, the light-exiting-side retardation element 61 converts the circularly polarized image light PL into the linearly polarized image light PL, so that the linearly polarized light PL is output from the light-exiting-side retardation element 61. Note that when the light-incident-side retardation element 60 and the light-exiting-side retardation element 61 are each configured, for example, with a λ/4 retardation film, the retardation elements 60 and 61 are so disposed that the slow axes of the retardation elements 60 and 61 are perpendicular to each other and the fast axes of the retardation elements 60 and 61 are perpendicular to each other.

On the other hand, when a voltage is applied to the liquid crystal layer 57 of the apparatus body 5D1 and the non-polarized image light PL is incident from the apparatus body 5D1, the light-exiting-side retardation element 61 imparts retardations to the non-polarized image light PL, so that the non-polarized image light PL is output from the light-exiting-side retardation element 61.

The light-exiting-side retardation element 61 can instead be configured with a λ/8 retardation film. In this case, when no voltage is applied to the liquid crystal layer 57 of the apparatus body 5D1 and the circularly polarized image light PL is incident from the apparatus body 5D1, the light-exiting-side retardation element 61 outputs elliptically polarized light PL.

On the other hand, when a voltage is applied to the liquid crystal layer 57 of the apparatus body 5D1 and the non-polarized image light PL is incident from the apparatus body 5D1, the light-exiting-side retardation element 61 outputs the non-polarized light PL.

### Advantages of Fourth Embodiment

The projector according to the present embodiment described above provides the following advantages as well as the same advantages provided by the projector according to the third embodiment.

In the projector as the projection apparatus according to the present embodiment, the polarization control apparatus 5D includes the light-incident-side retardation element 60, which is disposed at the side of the first substrate 51A that is opposite the second substrate 52A and generates retardations in the light that enters the light-incident-side retardation element 60.

When the light-incident-side retardation element 60 is not provided and the light that enters the polarization control apparatus is linearly polarized light, and when the polarization control apparatus converts the linearly polarized light into non-polarized light, the non-polarized light is not non-biased non-polarized light but is non-polarized light biased to one of the p-polarized light and the s-polarized light, which are each the linearly polarized light.

In contrast, when the light having passed through the light-incident-side retardation element 60 enters the first substrate 51A of the apparatus body 5D1, the polarization control apparatus 5D can output light having a more random non-polarized state. Light having an omnidirectionally less biased polarization state can therefore be output.

In the projector to the present embodiment, the light-incident-side retardation element 60 is a λ/4 retardation film.

According to the configuration described above, when linearly polarized light enters the light-incident-side retardation element 60, which is a λ/4 retardation film, the linearly polarized light is converted into circularly polarized light when passing through the light-incident-side retardation element 60 and enters the first substrate 51A. When the circularly polarized light enters the liquid crystal layer 57, light output from the polarization control apparatus 5D can be more random non-polarized light.

In the projector according to the present embodiment, the polarization control apparatus 5D includes the light-exiting-side retardation element 61, which is disposed at the side of the second substrate 52A that is opposite the first substrate 51A and generates retardations in the light that enters the light-exiting-side retardation element 61.

According to the configuration described above, the polarization state of the light output from the polarization control apparatus 5D can be controlled by the light-exiting-side retardation element 61.

For example, when the light that enters the polarization control apparatus 5D is linearly polarized light and the light-incident-side retardation element 60 and the light-exiting-side retardation element 61 are each a λ/4 retardation film, the polarization control apparatus 5D can output linearly polarized light when no voltage is applied to the liquid crystal layer 57, and the polarization control apparatus 5D can output non-polarized light when a voltage is applied to the liquid crystal layer 57.

Note that when the light that enters the polarization control apparatus 5D is linearly polarized light and the light-incident-side retardation element 60 and the light-exiting-side retardation element 61 are each a λ/8 retardation film, the polarization control apparatus 5D can output elliptically polarized light when no voltage is applied to the liquid crystal layer 57, and the polarization control apparatus 5D can output non-polarized light when a voltage is applied to the liquid crystal layer 57.

### Fifth Embodiment

A fifth embodiment of the present disclosure will next be described.

The projector according to the present embodiment differs from the projector according to the fourth embodiment in that the light-incident-side retardation element 60 and the light-exiting-side retardation element 61 are replaced with a light-incident-side variable retardation element and a light-exiting-side variable retardation element. In the following description, portions that are the same or substantially the same as the portions having been already described have the same reference characters and will not be described.

### Schematic Configurations of Projector and Image Projection Unit

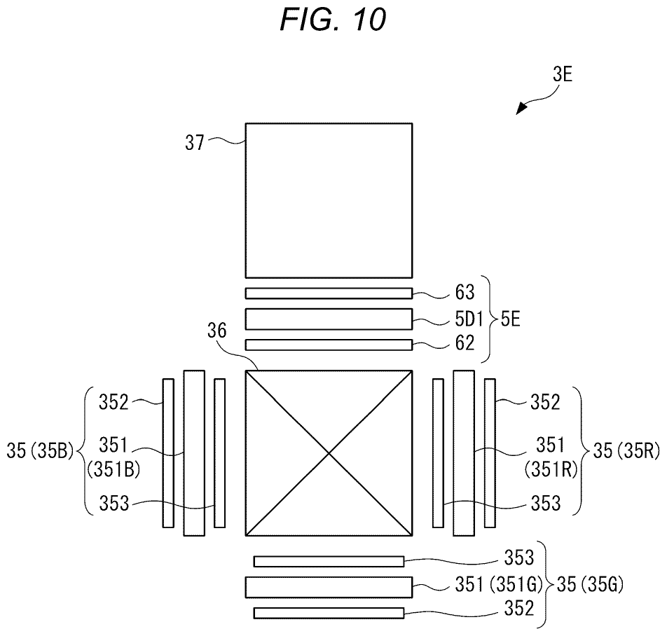

FIG. 10 is a diagrammatic view showing a portion of the configuration of an image projection unit 3E provided in the projector according to the present embodiment.

The projector according to the present embodiment has the same configurations and functions as the projector according to the first embodiment except that the image projection unit 3A is replaced with the image projection unit 3E, a portion of the configuration of which is shown in FIG. 10.

The image projection unit 3E has the same components and functions as the image projection unit 3A according to the first embodiment except that the polarization control apparatus 5A is replaced with a polarization control apparatus 5E. That is, the image projection unit 3E includes the light source 31, the color separator 32, the image forming apparatus 33, the projection lens 37, and the polarization control apparatus 5D.

### Configuration of Polarization Control Apparatus

The polarization control apparatus 5E has the same configurations and functions as the polarization control apparatus 5D according to the fourth embodiment except that the light-incident-side retardation element 60 and the light-exiting-side retardation element 61 are replaced with a light-incident-side variable retardation element 62 and a light-exiting-side variable retardation element 63. That is, the polarization control apparatus 5E includes the apparatus body 5D1 configured in the same manner as that of the polarization control apparatus 5C, the light-incident-side variable retardation element 62, and the light-exiting-side variable retardation element 63.

Note that the polarization control apparatus 5E is disposed between the light combiner 36 and the projection lens 37 in the optical path of the image light PL, and may instead be disposed with respect to the projection lens 37 to be located at the light exiting side of the projection lens 37.

### Configurations of Light-Incident-Side and Light-Exiting-Side Variable Retardation Elements

The light-incident-side variable retardation element 62 corresponds to the light-incident-side retardation element, and is disposed with respect to the apparatus body 5D1 to be located at the light incident side of the polarization control apparatus 5E. That is, the light-incident-side variable retardation element 62 is disposed between each of the light-exiting-side polarizer plates 353 and the apparatus body 5D1 in the optical path of the image light PL. In the present embodiment, the light-incident-side variable retardation element 62 is disposed between the light combiner 36 and the apparatus body 5D1 in the optical path of the image light PL.

The light-exiting-side variable retardation element 63 corresponds to the light-exiting-side retardation element, and is disposed with respect to the apparatus body 5D1 to be located at the light exiting side of the polarization control apparatus 5E. In the present embodiment, the light-exiting-side variable retardation element 63 is disposed between the apparatus body 5D1 and the projection lens 37 in the optical path of the image light PL.

The light-incident-side variable retardation element 62 and the light-exiting-side variable retardation element 63 thus sandwich the apparatus body 5D1 in the optical path of the image light PL.

Although not shown in detail, the light-incident-side variable retardation element 62 and the light-exiting-side variable retardation element 63 are each configured with a liquid crystal panel. For example, the variable retardation elements 62 and 63 are each configured with a liquid crystal panel including a polyimide film having been subjected to a rubbing treatment and hence having the orientation regulating force described above. The variable retardation elements 62 and 63 each change the retardations to be imparted to the light passing therethrough in accordance with the level of the applied voltage.

For example, when linearly polarized light enters the light-incident-side variable retardation element 62, the light-incident-side variable retardation element 62 converts the incident linearly polarized light into circularly polarized light and causes the circularly polarized light to enter the apparatus body 5D1. The light-incident-side variable retardation element 62 thus converts the polarization state of the image light PL incident from each of the light-exiting-side polarizer plates 353 via the light combiner 36 from linear polarization to circular polarization. Note that the light-incident-side variable retardation element 62 can instead transmit the incident light with the polarization state thereof unchanged.

Similarly, the light-exiting-side variable retardation element 63 can transmit the incident light with the polarization state thereof unchanged, or can transmit the incident light with the polarization state thereof changed.

The variable retardation elements 62 and 63 can thus each switch the operation thereof between the operation of substantially uniformly changing the polarization state of the incident light and the operation of unchanging the polarization state.

### Advantages of Fifth Embodiment

The projector according to the present embodiment described above provides the following advantages as well as the same advantages provided by the projector according to the fourth embodiment.

In the projector as the projection apparatus according to the present embodiment, the polarization control apparatus 5E includes the light-incident-side variable retardation element 62 and the light-exiting-side variable retardation element 63.

The configuration described above can increase the number of variations of the polarization state of the light output from the polarization control apparatus 5E, that is, the image light PL projected from the projector. The convenience of the polarization control apparatus 5E and the projector can therefore be improved.

### Sixth Embodiment

A sixth embodiment of the present disclosure will next be described.

### Configuration of Active State Regulation Apparatus

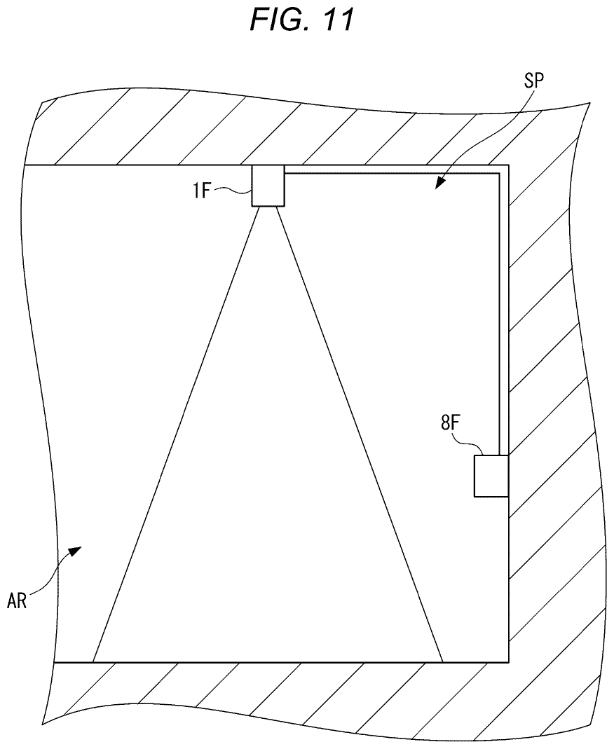

FIG. 11 is a diagrammatic view showing the configuration of an active state regulation apparatus AR according to the present embodiment.

The active state regulation apparatus AR according to the present embodiment is an action control apparatus that controls an action of an organism by irradiating the organism with linearly polarized image light or non-polarized image light. The active state regulation apparatus AR is used, for example, as an apparatus installed in an indoor space SP, as shown in FIG. 11.

The active state regulation apparatus AR includes a projector 1F and a control apparatus 8F.

### Configuration of Projector

The projector 1F is configured in the same manner as the projector according to the fourth or fifth embodiment. That is, the projector 1F includes the image projection unit 3D including the polarization control apparatus 5D or the image projection unit 3E including the polarization control apparatus 5E.

Note in the example shown in FIG. 11 that the projector 1F is provided at a ceiling that defines the space SP. That is, the projector 1F is disposed to be usable as an illumination projector that projects the image light PL downward to illuminate the space SP, but not necessarily. The projector 1F may instead project the image light PL along the horizontal direction or the upward direction.

### Configuration of Control Apparatus

The control apparatus 8F controls the operation of the projector 1F to cause the projector 1F to project linearly polarized image light and non-polarized image light separately. For example, to cause an organism to perform a predetermined action, the control apparatus 8F causes the projector 1F to irradiate the place where the organism is present or the vicinity of the place where the organism is present with one of the linearly polarized light and the non-polarized light. On the other hand, for example, to cause the organism not to perform the predetermined action, the control apparatus 8F causes the projector 1F to irradiate the place where the organism is present or the vicinity of the place where the organism is present with the other of the linearly polarized light and the non-polarized light. To cause the organism not to perform the predetermined action, the control apparatus 8F instead causes the projector 1F to stop radiating the one of the two types of light.

In the example shown in FIG. 11, the control apparatus 8F is disposed away from the projector 1F, but not necessarily. The control apparatus 8F may be integrated with the projector 1F, which is the projection apparatus. That is, the control apparatus 8F may be incorporated in the control section 7 of the projector 1F.

There are organisms capable of detecting polarized light. Many of such organisms can selectively detect polarized light components. It has been reported that when such organisms are irradiated with light having a specific polarization state, the organisms are encouraged to find feed or the organisms gather at or disperse from the light irradiated position. In addition, the light from a blue sky contains a polarized light component according to the angle of the light with respect to the sunlight, and some types of birds and insects can determine the position and direction of the sun based on the orientation of the sensed polarized light. The actions described above are caused by optical stimulation of a light receptor present in the eyes or other body sites of such an organism and a resultant change in the active state of the light receptor.

In view of the fact described above, the control apparatus 8F controls the operation of the projector 1F to stimulate the light receptor of the organism and regulate the active state of the light receptor, thereby controlling the action of the organism to some extent.

### Advantages of Sixth Embodiment

The active state regulation apparatus AR according to the present embodiment described above provides the following advantages as well as the same advantages provided by the projector 1A according to the first embodiment.

The active state regulation apparatus AR includes the projector 1F as the projection apparatus and the control apparatus 8F. The control apparatus 8F causes the projector 1F to irradiate an organism with the linearly polarized light and the non-polarized light separately to change the active state of the light receptor.

According to the configuration described above, for example, the control apparatus 8F causes the projector 1F to irradiate organisms present at the light irradiated position and in the vicinity thereof with the linearly polarized light and the non-polarized light separately to stimulate the light receptor of each of the organisms to change the active state of the light receptor. The action and growth of the organisms can therefore be controlled.

### Seventh Embodiment

A seventh embodiment of the present disclosure will next be described.

### Configuration of Circadian Rhythm Control Apparatus

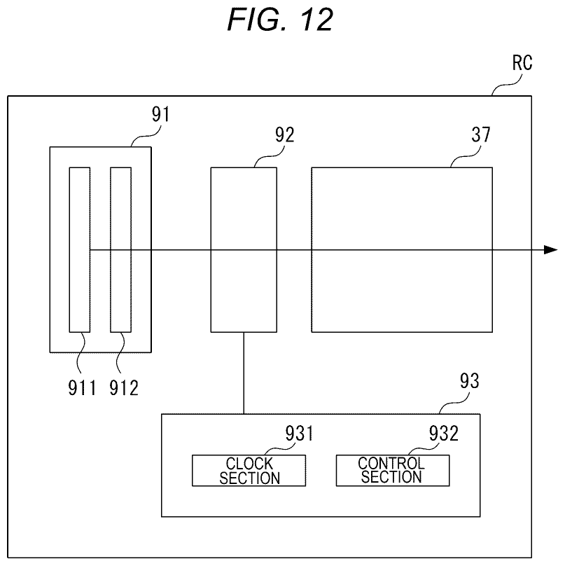

FIG. 12 is a diagrammatic view showing the configuration of a circadian rhythm control apparatus RC according to the present embodiment.

The circadian rhythm control apparatus RC according to the present embodiment is an apparatus that outputs light having a polarization state according to a time zone of a day to control the circadian rhythm of an organism. The circadian rhythm control apparatus RC is disposed and used, for example, in the indoor space SP, as the active state regulation apparatus AR according to the sixth embodiment.

The circadian rhythm control apparatus RC includes a light source 91, a polarization control apparatus 92, the projection lens 37, and a control apparatus 93, as shown in FIG. 12.

### Configuration of Light Source

The light source 91 outputs light that enters the polarization control apparatus 92. The light source 91 includes a light source section 911 and a polarizer plate 912.

The light source section 911 includes, for example, a light source lamp or multiple light emitters, and outputs light.

The polarizer plate 912 is disposed in the optical path of the light output from the light source section 911, transmits one of the s-polarized light and the p-polarized light, which are each linearly polarized light, and blocks the other linearly polarized light. The light passing through the polarizer plate 912 and output from the light source 91 is therefore one type of linearly polarized light. When the light source section 911 can output one of the s-polarized light and the p-polarized light, which are each linearly polarized light, the polarizer plate 912 can be omitted.

### Configurations of Polarization Control Apparatus and Projection Lens

The polarization control apparatus 92 is configured in the same manner as the polarization control apparatus 5D according to the fourth embodiment. The light output from the light source 91 enters the polarization control apparatus 92. The polarization control apparatus 92 outputs either the linearly polarized light or the non-polarized light under the control of the control apparatus 93. The polarization control apparatus 92 may be configured in the same manner as the polarization control apparatus 5E.

The projection lens 37 projects the light output from the polarization control apparatus 92.

### Configuration of Control Apparatus

The control apparatus 93 controls the operations of the light source 91 and the polarization control apparatus 92 to cause the polarization control apparatus 92 to output one of the linearly polarized light and the non-polarized light in accordance with the time zone.

The control apparatus 93 includes a clock section 931 and a control section 932.

The clock section 931 measures the present time.

The control section 932 controls the operations of the light source 91 and the polarization control apparatus 92 in accordance with the time measured by the clock section 931. For example, the control section 932 causes the polarization control apparatus 92 to output the linearly polarized light in the morning time zone and the evening time zone, and causes the polarization control apparatus 92 to output the non-polarized light in the daytime time zone. Specifically, the control section 932 causes the polarization control apparatus 92 to output the linearly polarized light in a time zone from 6 o'clock to 12 o'clock and a time zone from 17 o'clock to 18 o'clock, and causes the polarization control apparatus 92 to output the non-polarized light in a time zone from 12 o'clock to 17 o'clock.

The interior of the space SP can thus be irradiated with light having a polarization state that is substantially the same as the polarization state of the sunlight to which an organism is exposed outdoors. The circadian rhythm of the organism in the space SP can therefore be readily adjusted. Note that the time zone in which the linearly polarized light is output and the time zone in which the non-polarized light is output may be matched with the time in a region different from the region where the circadian rhythm control apparatus RC is disposed. Regulating the circadian rhythm as described above can suppress, for example, loss of mental faculties due to a time difference.

In addition to the above, at least one of the time zone in which the linearly polarized light is output and the time zone in which non-polarized light is output may be shortened so that the circadian rhythm of the organism is shortened.

### Advantages of Seventh Embodiment

The circadian rhythm control apparatus RC according to the present embodiment described above provides the advantages below.

The circadian rhythm control apparatus RC includes the light source 91, the polarization control apparatus 92, and the control apparatus 93.

The polarization control apparatus 92 has the same configuration as the polarization control apparatus 5D according to the fourth embodiment or the polarization control apparatus 5E according to the fifth embodiment. The polarization control apparatus 92 is disposed in the optical path of light output from the light source 91 and controls a polarization state of the incident light.

The control apparatus 93 controls the polarization control apparatus 92 to cause the polarization control apparatus to output one of the linearly polarized light and the non-polarized light in accordance with the time zone.

According to the configuration described above, the control apparatus 93 causes the polarization control apparatus 92 to output, for example, the linearly polarized light in the morning and the evening, and causes the polarization control apparatus 92 to output the non-polarized light in the daytime, so that the organism can be irradiated with light having a polarization state close to that of the sunlight in accordance with the time zone. The organism can therefore readily perceive the time zone, so that the circadian rhythm of the organism can be affected.

### Variations of Embodiments

The present disclosure is not limited to the embodiments described above, and variations, improvements, and other modifications to the extent that the advantage of the present disclosure is achieved fall within the scope of the present disclosure.

It has been assumed in each of the first to sixth embodiments that the projector as the projection apparatus includes the image projection unit 3A, 3D, or 3E, in which the light source 31, the color separator 32, the image forming apparatus 33, and the projection lens 37 are arranged in the layout shown in FIG. 1. The optical parts provided in the image projection unit provided in the projector and the layout of the optical parts are not limited to those described above, and can be changed as appropriate.

In the seventh embodiment described above, the polarization control apparatus 92 provided in the circadian rhythm control apparatus RC is configured in the same manner as the polarization control apparatus 5D according to the fourth embodiment or the polarization control apparatus 5E according to the fifth embodiment, but not necessarily. The polarization control apparatus 92 may be configured in the same manner as the polarization control apparatus 5A according to the first embodiment, the polarization control apparatus 5B according to the second embodiment, or the polarization control apparatus 5C according to the third embodiment.

In each of the embodiments described above, the projector includes the three light modulators 35R, 35G, and 35B, but not necessarily. The present disclosure is also applicable to a projector including two or fewer or four or larger number of light modulators.

It has been assumed in the embodiments described above that the light modulation modules 351 provided in the light modulators 35 are each a transmissive liquid crystal panel having a light incident surface and a light exiting surface different from each other, but not necessarily. The light modulation modules 351 may each be a reflective liquid crystal panel having a surface that serves both as the light incident surface and the light exiting surface. Furthermore, a light modulator using any element other than a liquid-crystal-based element, such as a device using micromirrors, for example, a digital micromirror device (DMD), may be employed as long as the element is capable of modulating an incident luminous flux to form an image according to image information. In this case, in the optical path of the image light PL, a polarizer that transmits one of the s-polarized light and the p-polarized light, which are each linearly polarized light, and blocks the other polarized light may be provided between a non-liquid-crystal-based light modulator and each of the polarization control apparatuses 5A, 5B, 5C, 5D, and 5E.

The first to sixth embodiments have been described with reference to the case where the polarization control apparatuses 5A, 5B, 5C, 5D, and 5E are each applied to a projector that is the projection apparatus, but not necessarily. Any of the polarization control apparatuses of the present disclosure may be used in an electronic instrument other than a projector, for example, an illuminator, as described in the seventh embodiment.

### Summary of Present Disclosure

The present disclosure will be summarized below as additional remarks.

### Additional Remark 1

A projection apparatus including:
a light modulator configured to modulate incident light based on an image signal;
a projection lens configured to project light output from the light modulator; and
a polarization control apparatus disposed at a light exiting side of the light modulator in an optical path of the light output from the light modulator and to be projected by the projection lens, and configured to control a polarization state of the light modulated by the light modulator,
wherein the polarization control apparatus includes
a first substrate,
a second substrate disposed to face the first substrate,
a first organic film layered on the first substrate and having no orientation regulating force that regulates orientations of liquid crystal molecules,
a second organic film layered on the second substrate and having no orientation regulating force that regulates the orientations of the liquid crystal molecules, and
a liquid crystal layer disposed between the first organic film and the second organic film, and
the liquid crystal layer contains the multiple liquid crystal molecules arranged with major axes thereof oriented disorderly with respect to the first and second organic films.

According to the configuration described above, in the polarization control apparatus, the first and second organic films each have no orientation regulating force that regulates the orientations of the liquid crystal molecules. For example, the first and second organic films have been subjected to no rubbing treatment. The liquid crystal molecules are therefore arranged with the major axes thereof oriented disorderly in the liquid crystal layer disposed between the first and second organic films. Since the modulated light modulated by the light modulators passes through the thus configured polarization control apparatus, retardations are disorderly imparted to the modulated light when the modulated light passes through the liquid crystal layer. The modulated light output from the polarization control apparatus is therefore random non-polarized light having a low degree of polarization. The light projected from the projection apparatus can therefore be light having a more random polarization state.

### Additional Remark 2

The projection apparatus according to the additional remark 1, wherein
the polarization control apparatus includes
a first electrically conductive layer disposed between the first substrate and the first organic film, and
a second electrically conductive layer disposed between the second substrate and the second organic film.

According to the configuration described above, in which the first and second electrically conductive layers are formed, the multiple liquid crystal molecules can be readily arranged disorderly. In addition, when the first and second organic films are formed, the uniformity of each of the organic films can be readily secured.

### Additional Remark 3

The projection apparatus according to the additional remark 2, further including
a control section configured to apply a voltage to the liquid crystal layer,
wherein the first electrically conductive layer constitutes a first electrode electrically coupled to the control section, and
the second electrically conductive layer constitutes a second electrode electrically coupled to the control section.

According to the configuration described above, the control section can change the orientation angle of each of the liquid crystal molecules by applying a voltage to the liquid crystal layer via the first electrode configured with the first electrically conductive layer and the second electrode configured with the second electrically conductive layer. That is, the control section can change how each of the liquid crystal molecules tilts by applying a voltage to the liquid crystal layer. The degree of polarization of the light output from the polarization control apparatus can therefore be regulated.

### Additional Remark 4

The projection apparatus according to the additional remark 1, wherein
a surface of the first substrate that faces the first organic film is a first surface-activated surface,
the first organic film is provided at the first surface-activated surface,
a surface of the second substrate that faces the second organic film is a second surface-activated surface, and
the second organic film is provided at the second surface-activated surface.

According to the configuration described above, the multiple liquid crystal molecules can be readily arranged disorderly when the first substrate is not provided with the first electrically conductive layer and the second substrate is not provided with the second electrically conductive layer.

### Additional Remark 5

The projection apparatus according to any one of the additional remarks 1 to 4, wherein
the liquid crystal molecules are negative nematic liquid crystal molecules.

According to the configuration described above, when the liquid crystal molecules are so arranged that the major axis directions of the liquid crystal molecules are along the organic films, retardations are readily imparted to the modulated light passing through the liquid crystal molecules. The polarization control apparatus can therefore readily form random non-polarized light.

### Additional Remark 6

A projection apparatus including:
a light modulator configured to modulate incident light based on an image signal;
a projection lens configured to project light output from the light modulator; and
a polarization control apparatus disposed at a light exiting side of the light modulator in an optical path of the light output from the light modulator and to be projected by the projection lens, and configured to control a polarization state of the light modulated by the light modulator,
wherein the polarization control apparatus includes
a first substrate having a light incident surface on which light is incident,
a second substrate disposed to face the first substrate,
a first electrode disposed at a surface of the first substrate that is opposite the light incident surface,
a first vertical orientation film layered on the first electrode and having no orientation regulating force that regulates orientations of liquid crystal molecules during voltage application,
a second electrode disposed at a surface of the second substrate that faces the first substrate,
a second vertical orientation film layered on the second electrode and having no orientation regulating force that regulates the orientations of the liquid crystal molecules during the voltage application, and
a liquid crystal layer disposed between the first vertical orientation film and the second vertical orientation film, and containing the multiple liquid crystal molecules oriented randomly by the application of a voltage to the first and second electrodes.

According to the configuration described above, the light to be projected can be light having a random non-polarized state, as in the projection apparatus according to the additional remark 1 described above.

That is, in the state in which no voltage is applied to the liquid crystal layer, the vertical orientation films orient the liquid crystal molecules perpendicularly to the vertical orientation films. On the other hand, when a voltage is applied to the liquid crystal layer, the multiple liquid crystal molecules tilt in random directions with respect to an imaginary plane parallel to the vertical orientation films. Since the modulated light modulated by the light modulators passes through the thus configured polarization control apparatus, retardations are disorderly imparted to the modulated light when the modulated light passes through the liquid crystal layer. The modulated light output from the polarization control apparatus is therefore random non-polarized light having a low degree of polarization. The light projected from the projection apparatus can therefore be light having a more random polarization state.

### Additional Remark 7

The projection apparatus according to the additional remark 6, wherein
the polarization control apparatus includes a light-incident-side retardation element disposed at a side of the first substrate that is opposite the second substrate and configured to generate retardations in light that enters the light-incident-side retardation element.

When the light-incident-side retardation element is not provided and the light that enters the polarization control apparatus is linearly polarized light, and when the polarization control apparatus converts the linearly polarized light into non-polarized light, the non-polarized light is not non-biased non-polarized light but is non-polarized light biased to one of p-polarized light and s-polarized light, which are each linearly polarized light.

In contrast, when the light having passed through the light-incident-side retardation element enters the first substrate, the polarization control apparatus can output light having a more random non-polarized state. Light having an omnidirectionally less biased polarization state can therefore be output.

### Additional Remark 8

The projection apparatus according to the additional remark 7, wherein
the light-incident-side retardation element is a λ/4 retardation film.

According to the configuration described above, when linearly polarized light enters the light-incident-side retardation element, which is a λ/4 retardation film, the linearly polarized light is converted into circularly polarized light when passing through the light-incident-side retardation element and enters the first substrate. When the circularly polarized light enters the liquid crystal layer, light output from the polarization control apparatus can be more random non-polarized light.

### Additional Remark 9

The projection apparatus according to the additional remark 7 or 8, wherein
the polarization control apparatus includes a light-exiting-side retardation element disposed at a side of the second substrate that is opposite the first substrate and configured to generate retardations in light that enters the light-exiting-side retardation element.

According to the configuration described above, the polarization state of the light output from the polarization control apparatus can be controlled by the light-exiting-side retardation element.

For example, when the light that enters the polarization control apparatus is linearly polarized light and the light-incident-side retardation element and the light-exiting-side retardation element are each a λ/4 retardation film, and when the slow axes of the retardation elements are perpendicular to each other and the fast axes of the retardation elements are perpendicular to each other, the polarization control apparatus can output linearly polarized light when no voltage is applied to the liquid crystal layer, and the polarization control apparatus can output non-polarized light when a voltage is applied to the liquid crystal layer.

For example, when the light that enters the polarization control apparatus is linearly polarized light and the light-incident-side retardation element and the light-exiting-side retardation element are each a λ/8 retardation film, the polarization control apparatus can output elliptically polarized light when no voltage is applied to the liquid crystal layer, and the polarization control apparatus can output non-polarized light when a voltage is applied to the liquid crystal layer.

### Additional Remark 10

An active state regulation apparatus including:
the projection apparatus according to any one of additional remarks 1 to 9; and
a control apparatus configured to cause the projection apparatus to radiate linearly polarized light and non-polarized light separately to change an active state of a light receptor.

There are organisms capable of detecting polarized light. It has been reported that when light having a specific polarization state enters such organisms, the organisms actively find feed or the organisms gather at or disperse from the light irradiated position. In addition, the light from a blue sky contains a polarized light component according to the angle of the light with respect to the sunlight, and some types of birds and insects can determine the position and direction of the sun based on the orientation of the sensed polarized light. The actions described above are caused by optical stimulation of a light receptor present in the eyes or other body sites of such an organism and a resultant change in the active state of the light receptor.

Therefore, according to the configuration described above, for example, the control apparatus causes the projection apparatus to irradiate organisms present at the light irradiated position and in the vicinity thereof with the linearly polarized light and the non-polarized light separately irrespective of the time zone to stimulate the light receptor of each of the organisms to change the active state of the light receptor. The action and growth of the organisms can therefore be controlled.

### Additional Remark 11

A polarization control apparatus including:
a first substrate;
a second substrate disposed to face the first substrate;
a first organic film layered on the first substrate and having no orientation regulating force that regulates orientations of liquid crystal molecules;
a second organic film layered on the second substrate and having no orientation regulating force that regulates the orientations of the liquid crystal molecules; and
a liquid crystal layer disposed between the first organic film and the second organic film and containing the liquid crystal molecules arranged with major axes thereof oriented disorderly with respect to the first and second organic films.

The configuration described above can provide the same advantages provided by the projection apparatus according to the additional remark 1 described above.

That is, in the polarization control apparatus, the first and second organic films each have no orientation regulating force that regulates the orientations of the liquid crystal molecules. For example, the first and second organic films have been subjected to no rubbing treatment. The liquid crystal molecules are therefore arranged with the major axes thereof oriented disorderly in the liquid crystal layer disposed between the first and second organic films. When light enters the thus configured polarization control apparatus, retardations are disorderly imparted to the light passing through the liquid crystal layer. The light output from the polarization control apparatus can therefore be random non-polarized light having a low degree of polarization.

### Additional Remark 12

The polarization control apparatus according to the additional remark 11, further including:
a first electrically conductive layer disposed between the first substrate and the first organic film and layered thereon, and
a second electrically conductive layer disposed between the second substrate and the second organic film and layered thereon.

According to the configuration described above, the multiple liquid crystal molecules can be readily arranged disorderly, as in the projection apparatus according to the additional remark 2 described above.

### Additional Remark 13

The polarization control apparatus according to the additional remark 12, wherein
the first electrically conductive layer constitutes a first electrode, and
the second electrically conductive layer constitutes a second electrode.

The configuration described above can change the orientation angle of each of the liquid crystal molecules by applying a voltage to the liquid crystal layer via the first electrode configured with the first electrically conductive layer and the second electrode configured with the second electrically conductive layer, as in the projection apparatus according to the additional remark 3 described above. That is, how each of the liquid crystal molecules tilts can be changed by applying a voltage to the liquid crystal layer. The degree of polarization of the light output from the polarization control apparatus can therefore be regulated.

### Additional Remark 14

The polarization control apparatus according to the additional remark 11, wherein
a surface of the first substrate that faces the first organic film is a first surface-activated surface,
the first organic film is provided at the first surface-activated surface,
a surface of the second substrate that faces the second organic film is a second surface-activated surface, and
the second organic film is provided at the second surface-activated surface.

According to the configuration described above, the multiple liquid crystal molecules can be readily arranged disorderly when the first substrate is not provided with the first electrically conductive layer and the second substrate is not provided with the second electrically conductive layer, as in the projection apparatus according to the additional remark 4 described above.

### Additional Remark 15

The polarization control apparatus according to any one of the additional remarks 11 to 14, wherein
the liquid crystal molecules are negative nematic liquid crystal molecules.

According to the configuration described above, when the liquid crystal molecules are so arranged that the major axis directions of the liquid crystal molecules are along the organic films, retardations are readily imparted to the modulated light passing through the liquid crystal molecules, as in the projection apparatus according to the additional remark 5. The polarization control apparatus can therefore readily form random non-polarized light.

### Additional Remark 16

A polarization control apparatus including:
a first substrate;
a second substrate disposed to face the first substrate;
a first electrode provided at a surface of the first substrate that faces the second substrate;
a first vertical orientation film layered on the first electrode and having no orientation regulating force that regulates orientations of liquid crystal molecules during voltage application;
a second electrode disposed at a surface of the second substrate that faces the first substrate;
a second vertical orientation film layered on the second electrode and having no orientation regulating force that regulates the orientations of the liquid crystal molecules during the voltage application, and
a liquid crystal layer disposed between the first vertical orientation film and the second vertical orientation film, and containing the liquid crystal molecules oriented randomly by the application of a voltage to the first and second electrodes.

According to the configuration described above, the light to be output can be light having a random non-polarized state, as in the polarization control apparatus according to the additional remark 11 described above.

That is, in the state in which no voltage is applied to the liquid crystal layer, the vertical orientation films orient the liquid crystal molecules perpendicularly to the vertical orientation films. On the other hand, when a voltage is applied to the liquid crystal layer, the multiple liquid crystal molecules tilt in random directions with respect to an imaginary plane parallel to the vertical orientation films. Retardations are disorderly imparted to the light passing through the liquid crystal layer of the thus configured polarization control apparatus. The light output from the polarization control apparatus can therefore be random non-polarized light having a low degree of polarization.

### Additional Remark 17

The polarization control apparatus according to the additional remark 16, further including
a light-incident-side retardation element disposed at a side of the first substrate that is opposite the second substrate and configured to generate retardations in light that enters the light-incident-side retardation element.

According to the configuration described above, the polarization control apparatus can output light having a more random non-polarized state, as in the projection apparatus according to the additional remark 7 described above. Light having an omnidirectionally less biased polarization state can therefore be output.

### Additional Remark 18

The polarization control apparatus according to the additional remark 17, wherein
the light-incident-side retardation element is a λ/4 retardation film.

According to the configuration described above, which causes the linearly polarized light to enter the light-incident-side retardation element, which is a λ/4 retardation film, and causes the circularly polarized light to enter the liquid crystal layer, the light output from the polarization control can apparatus be more random non-polarized light, as in the projection apparatus according to the additional remark 8 described above.

### Additional Remark 19

The polarization control apparatus according to the additional remark 17 or 18, further including
a light-exiting-side retardation element disposed at a side of the second substrate that is opposite the first substrate and configured to generate retardations in light that enters the light-exiting-side retardation element.

According to the configuration described above, the polarization state of the light output from the polarization control apparatus can be controlled by the light-exiting-side retardation element, as in the projection apparatus according to the additional remark 9 described above.

### Additional Remark 20

A circadian rhythm control apparatus including:
a light source;
the polarization control apparatus according to any one of the additional remarks 11 to 19, which is disposed in an optical path of light output from the light source and configured to control a polarization state of light that enters the polarization control apparatus; and
a control apparatus configured to control the polarization control apparatus to cause the polarization control apparatus to output one of linearly polarized light and non-polarized light in accordance with a time zone.

According to the configuration described above, for example, light having a polarization state close to that of the sunlight can be radiated in accordance with a time zone by radiating the linearly polarized light in the morning and in the evening and radiating the non-polarized light in the daytime. Organisms can therefore readily perceive the time zone, so that the circadian rhythm of the organisms can be affected and controlled.

What is claimed is:

1. A projection apparatus including:
a light modulator configured to modulate incident light based on an image signal;
a projection lens configured to project light output from the light modulator; and
a polarization control apparatus disposed at a light exiting side of the light modulator in an optical path of the light output from the light modulator and to be projected by the projection lens, and configured to control a polarization state of the light modulated by the light modulator,
wherein the polarization control apparatus includes
a first substrate,
a second substrate disposed to face the first substrate,
a first organic film layered on the first substrate and having no orientation regulating force that regulates orientations of liquid crystal molecules,
a second organic film layered on the second substrate and having no orientation regulating force that regulates the orientations of the liquid crystal molecules, and
a liquid crystal layer disposed between the first organic film and the second organic film, and
the liquid crystal layer contains the multiple liquid crystal molecules arranged with major axes thereof oriented disorderly with respect to the first and second organic films.

2. The projection apparatus according to claim 1, wherein
the polarization control apparatus includes
a first electrically conductive layer disposed between the first substrate and the first organic film, and
a second electrically conductive layer disposed between the second substrate and the second organic film.

3. The projection apparatus according to claim 2, further comprising
a control section configured to apply a voltage to the liquid crystal layer,
wherein the first electrically conductive layer constitutes a first electrode electrically coupled to the control section, and
the second electrically conductive layer constitutes a second electrode electrically coupled to the control section.

4. The projection apparatus according to claim 1, wherein
a surface of the first substrate that faces the first organic film is a first surface-activated surface,
the first organic film is provided at the first surface-activated surface,
a surface of the second substrate that faces the second organic film is a second surface-activated surface, and
the second organic film is provided at the second surface-activated surface.

5. The projection apparatus according to claim 1, wherein
the liquid crystal molecules are negative nematic liquid crystal molecules.

6. A projection apparatus comprising:
a light modulator configured to modulate incident light based on an image signal;
a projection lens configured to project light output from the light modulator; and
a polarization control apparatus disposed at a light exiting side of the light modulator in an optical path of the light output from the light modulator and to be projected by the projection lens, and configured to control a polarization state of the light modulated by the light modulator,
wherein the polarization control apparatus includes
a first substrate having a light incident surface on which light is incident,
a second substrate disposed to face the first substrate,
a first electrode disposed at a surface of the first substrate that is opposite the light incident surface,
a first vertical orientation film layered on the first electrode and having no orientation regulating force that regulates orientations of liquid crystal molecules during voltage application,
a second electrode disposed at a surface of the second substrate that faces the first substrate,
a second vertical orientation film layered on the second electrode and having no orientation regulating force that regulates the orientations of the liquid crystal molecules during the voltage application, and
a liquid crystal layer disposed between the first vertical orientation film and the second vertical orientation film, and containing the multiple liquid crystal molecules oriented randomly by the application of a voltage to the first and second electrodes.

7. The projection apparatus according to claim 6, wherein
the polarization control apparatus includes a light-incident-side retardation element disposed at a side of the first substrate that is opposite the second substrate and configured to generate retardations in light that enters the light-incident-side retardation element.

8. The projection apparatus according to claim 7, wherein
the light-incident-side retardation element is a λ/4 retardation film.

9. The projection apparatus according to claim 7, wherein
the polarization control apparatus includes a light-exiting-side retardation element disposed at a side of the second substrate that is opposite the first substrate and configured to generate retardations in light that enters the light-exiting-side retardation element.

10. An active state regulation apparatus comprising:
the projection apparatus according to claim 1; and
a control apparatus configured to cause the projection apparatus to radiate linearly polarized light and non-polarized light separately to change an active state of a light receptor.

11. A polarization control apparatus comprising:
a first substrate;
a second substrate disposed to face the first substrate;
a first organic film layered on the first substrate and having no orientation regulating force that regulates orientations of liquid crystal molecules;
a second organic film layered on the second substrate and having no orientation regulating force that regulates the orientations of the liquid crystal molecules; and
a liquid crystal layer disposed between the first organic film and the second organic film and containing the liquid crystal molecules arranged with major axes thereof oriented disorderly with respect to the first and second organic films.

12. The polarization control apparatus according claim 11, further comprising:
a first electrically conductive layer disposed between the first substrate and the first organic film and layered thereon, and
a second electrically conductive layer disposed between the second substrate and the second organic film and layered thereon.

13. The polarization control apparatus according to claim 12, wherein
the first electrically conductive layer constitutes a first electrode, and
the second electrically conductive layer constitutes a second electrode.

14. The polarization control apparatus according to claim 11, wherein
a surface of the first substrate that faces the first organic film is a first surface-activated surface,
the first organic film is provided at the first surface-activated surface,
a surface of the second substrate that faces the second organic film is a second surface-activated surface, and
the second organic film is provided at the second surface-activated surface.

15. The polarization control apparatus according to claim 11, wherein
the liquid crystal molecules are negative nematic liquid crystal molecules.

16. A polarization control apparatus comprising:
a first substrate;
a second substrate disposed to face the first substrate;
a first electrode provided at a surface of the first substrate that faces the second substrate;
a first vertical orientation film layered on the first electrode and having no orientation regulating force that regulates orientations of liquid crystal molecules during voltage application;
a second electrode disposed at a surface of the second substrate that faces the first substrate;
a second vertical orientation film layered on the second electrode and having no orientation regulating force that regulates the orientations of the liquid crystal molecules during the voltage application, and
a liquid crystal layer disposed between the first vertical orientation film and the second vertical orientation film, and containing the liquid crystal molecules oriented randomly by the application of a voltage to the first and second electrodes.

17. The polarization control apparatus according to claim 16, further comprising
a light-incident-side retardation element disposed at a side of the first substrate that is opposite the second substrate and configured to generate retardations in light that enters the light-incident-side retardation element.

18. The polarization control apparatus according to claim 17, wherein
the light-incident-side retardation element is a λ/4 retardation film.

19. The polarization control apparatus according to claim 17, further comprising
a light-exiting-side retardation element disposed at a side of the second substrate that is opposite the first substrate and configured to generate retardations in light that enters the light-exiting-side retardation element.

20. A circadian rhythm control apparatus comprising:
a light source;
the polarization control apparatus according to claim 11, which is disposed in an optical path of light output from the light source and configured to control a polarization state of light that enters the polarization control apparatus; and
a control apparatus configured to control the polarization control apparatus to cause the polarization control apparatus to output one of linearly polarized light and non-polarized light in accordance with a time zone.
